(19) United States
(12) Patent Application Publication
(10) Pub. No.: US 2011/0129705 A1
(43) Pub. Date: Jun. 2, 2011

(54) Battery Pack for Preventing Damage Due to External Shock

(75) Inventor: Tae-Jong Lee, Yongin-si (KR)

(73) Assignee: SAMSUNG SDI CO., LTD., Yongin-si (KR)

(21) Appl. No.: 12/911,589

(22) Filed: Oct. 25, 2010

(30) Foreign Application Priority Data
Nov. 30, 2009 (KR) 10-2009-0116672

(51) Int. Cl. H01M 10/02

(52) U.S. Cl. 429/90

(57) ABSTRACT

A battery pack is capable of preventing problems from occurring due to the damage of a secondary battery when external shock is applied. The battery pack includes battery cells serially coupled, coupled in parallel, or coupled in a combination of series and parallel, a shock detecting unit for detecting external shock, and a controller coupled to the battery cell and the shock detecting unit to output sensed shock information to the outside.

### CLAIM OF PRIORITY

This application makes reference to, incorporates the same herein, and claims all benefits accruing under 35 U.S.C. §119 from an application earlier filed in the Korean Intellectual Property Office on Nov. 30, 2009 and there duly assigned Serial No. 10-2009-0116672.

### BACKGROUND OF THE INVENTION

1. Field of the Invention

The present invention relates to a battery pack and, more particularly, to a battery pack capable of preventing problems from occurring due to the damage of secondary batteries when external shock is applied to the battery pack or the battery pack falls.

2. Description of the Related Art

In general, with respect to a battery pack in which lithium secondary batteries are built-in, a safety problem may be generated by the lithium secondary batteries when external shock is applied to the battery pack or the battery pack falls. In particular, in the case of the battery pack mounted in a laptop computer and an electric bicycle, the safety problem of the battery pack which may occur when the external shock is applied to the battery pack or the battery pack falls must be seriously considered.

### SUMMARY OF THE INVENTION

Accordingly, the present invention has been developed to provide a battery pack capable of preventing problems from occurring due to damage to secondary batteries when external shock is applied to the battery pack or the battery pack falls.

The present invention has also been developed to provide a battery pack capable of outputting phased information for the estimated damage of secondary batteries in accordance with external shock or the intensity of a fall.

In order to achieve the foregoing and/or other aspects of the present invention, according to an aspect of the present invention, there is provided a battery pack, including a battery cell serially coupled, coupled in parallel, or coupled in a combination of series and parallel, a shock detecting unit for detecting external shock, and a controller coupled to the battery cell and the shock detecting unit to output sensed shock information to the outside.

The shock detecting unit generates a voltage or current of a level corresponding to an intensity of the external shock.

The shock detecting unit includes a substrate and a plurality of conductive patterns mounted on the substrate and electrically coupled to each other in parallel. At least parts of the plurality of conductive patterns are broken together with the substrate by the external shock.

Each of the conductive patterns includes first and second conductive layers separated from each other by a predetermined distance, and the first and second conductive layers are coupled to each other by a conductive fuse member. The conductive fuse member deviates from its correct place due to the external shock so as to electrically separate the first and second conductive layers from each other.

The shock detecting unit includes a shock sensor for generating a voltage or current of a level corresponding to the external shock. The shock detecting unit includes a piezoelectric type acceleration sensor.

The battery pack further includes an external terminal, including a pair of power source terminals coupled to the battery cell. The battery pack further includes an output unit for outputting information as to the external shock.

The output unit is provided in the external terminal, is coupled to the controller, and transmits control signals to an external system.

The output unit includes a light output apparatus, a sound output apparatus, and a vibration apparatus coupled to the controller and one of the combinations of the above apparatuses.

The controller includes a blocking unit for blocking charge and discharge of the battery cell.

In the battery pack in which the lithium secondary batteries are built-in, the estimated damage to the secondary batteries when the external shock is applied to the battery pack or the battery pack falls or collides is displayed outside the battery pack or is transmitted to the external system of a user so that occurrence of problems due to the damage of the secondary batteries may be prevented. Phased information on the estimated damage may be outputted from the battery pack or may be transmitted to a user in accordance with the intensity of the external shock. Therefore, the stability and reliability of the battery pack may be improved.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1A is a schematic perspective view of a battery pack according to an embodiment of the invention;

FIG. 1B is a schematic block diagram illustrating the battery pack of FIG. 1;

FIGS. 2A and 2B are schematic plan views illustrating a shock detecting unit of the battery pack constructed as an embodiment of the invention;

FIGS. 3A and 3B are schematic plan views illustrating a shock detecting unit of a battery pack constructed as another embodiment of the invention;

FIG. 4 is a schematic perspective view illustrating a shock detecting unit of a battery pack constructed as still another embodiment of the invention; and

FIG. 5 is a schematic circuit diagram illustrating the controller of the battery pack constructed as an embodiment of the invention.

### DETAILED DESCRIPTION OF THE INVENTION

In the following detailed description, only certain exemplary embodiments of the present invention have been shown and described, simply by way of illustration. As those skilled in the art will realize, the described embodiments may be modified in various different ways, all without departing from the spirit or scope of the present invention. Accordingly, the drawings and description are to be regarded as illustrative in nature and not restrictive. In addition, when an element is referred to as being “on” another element, it can be directly on another element or be indirectly on another element with one or more intervening elements interposed therebetween. Also, when an element is referred to as being “connected to” another element, it can be directly connected to another element or be indirectly connected to another element with one or more intervening elements interposed therebetween. Hereinafter, like reference numerals refer to like elements.

Furthermore, embodiments of the present invention and items required for those skilled in the art to easily understand the content of the present invention will be described in detail below. Since the present invention may be realized by various patterns within the scope of the claims, the embodiments described hereinafter are only exemplary.

In describing the present invention, when it is determined that a related well-known function or detailed description of the structure may render the subject matter of the present invention unclear, a detailed description thereof will be omitted. Like reference numerals refer to like elements although the elements are displayed on different drawings. The thickness or size of a layer may be exaggerated for the sake of convenience or for clarity, and may be different from the actual thickness or size of an actual layer.

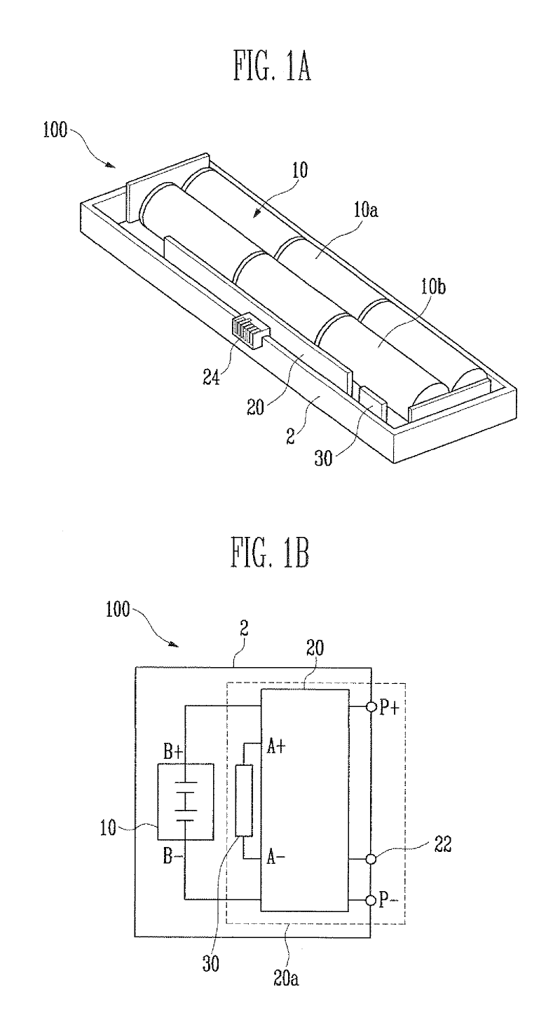

FIG. 1A is a schematic perspective view of a battery pack constructed as an embodiment of the invention, and FIG. 1B is a schematic block diagram illustrating the battery pack of FIG. 1.

Referring to FIGS. 1A and 1B, a battery pack 100 includes a plurality of secondary batteries 10, a controller 20, and a shock detecting unit 30. The battery pack 100 may include a case 2 including at least one of the plurality of secondary batteries 10, the controller 20, and the shock detecting unit 30. In addition, the battery pack 100 may include power source terminals P+ and P− so as to be electrically coupled to an external apparatus. The power source terminals P+ and P− are coupled to the positive electrode terminals B+ and the negative electrode terminals B− of the plurality of secondary batteries (hereinafter, referred to as battery cells 10).

The battery cells 10 may be serially coupled, may be coupled in parallel, or may be coupled in a combination of series and parallel. For example, in the battery cells 10, a first battery cell 10a in which three lithium secondary batteries are serially coupled and a second battery cell 10b in which other three lithium secondary batteries are serially coupled are coupled to each other in parallel. The secondary battery may be a cylindrical lithium secondary battery.

The controller 20 controls the operation of the battery cells 10. For example, the controller 20 controls the charge and discharge operations of the battery cells 10, and operates to protect the battery cells 10 in overcharge, overdischarge, and overcurrent states.

The controller 20 may be realized by a common battery management unit (BMU). The shock detecting unit 30 is coupled to or mounted in the controller 20 according to the present embodiment of the invention. In addition, the controller 20 according to the present invention transmits the shock information sensed by the shock detecting unit 30 to the outside, or outputs the shock information sensed by the shock detecting unit 30 to the outside. Therefore, an output unit 22 for transmitting or outputting the shock information to the outside is provided in the battery pack 100.

The output unit 22 may include a control line or a control terminal coupled to the controller 20. For example, the output unit 22 may be one control terminal provided in an external terminal 24. In this case, the control terminal transmits the shock information output from the controller 20 to an external system, such as a laptop computer. The control terminal may be provided in the external terminal 24 together with the power source terminals P+ and P−.

In addition, the output unit 22 may display information on the external shock outside the battery 100. For example, the output unit 22 may include one of a light output apparatus, a sound output apparatus including a buzzer, a vibration apparatus including a vibrator in which the weight center of a pendulum deviates from the rotation shaft of a direct current (DC) vibrator, and a combination of the above apparatuses.

The controller 20, the shock detecting unit 30, and the external terminal 24 may be mounted on a single substrate 20a.

Hereinafter, embodiments which may be applied to the above-described shock detecting unit 30 will be described in detail.

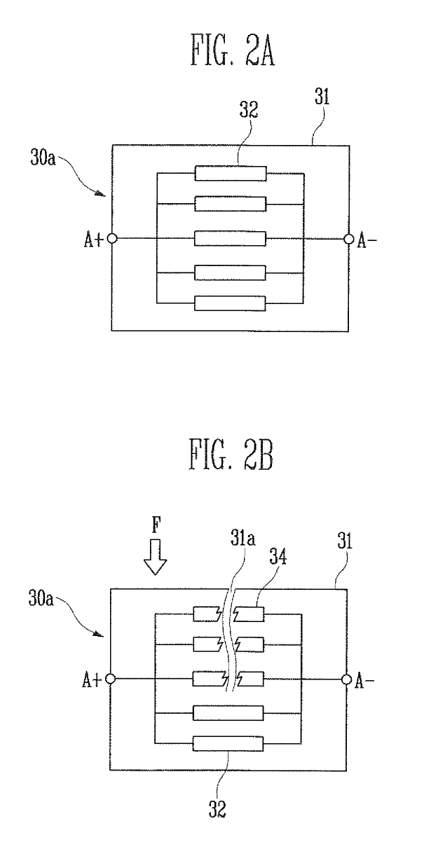

FIGS. 2A and 2B are schematic plan views illustrating a shock detecting unit of the battery pack constructed as an embodiment of the invention.

Referring to FIGS. 2A and 2B, a shock detecting unit 30a includes a substrate 31 and a plurality of conductive patterns 32 mounted on the substrate 31. The conductive patterns 32 are electrically coupled to each other in parallel. Both ends A+ and A− of the plurality of conductive patterns 32 are electrically coupled to the controller 20 of FIGS. 1A and 1B.

The substrate 31 may be formed of a printed circuit board easily manufactured and having a low price. The substrate 31 has a strength at which the substrate 31 is at least partially broken when no less than a predetermined degree of external shock is applied. For example, the substrate 31 is broken when no less than a predetermined degree of shock at which the inside of the lithium secondary battery is expected to be damaged is applied or the substrate 31 falls.

The conductive patterns 32 operate as resistors having actually the same resistance. For example, when it is assumed that one conductive pattern 32 has a resistance value of R[Ω], the parallel circuit of the five conductive patterns 32 has the resistance value of R/5[Ω], which is smaller than the resistance value of one conductive pattern.

In addition, the conductive patterns 32 are provided so that at least a partial conductive pattern is broken when the substrate 31 is broken. For example, the plurality of conductive patterns 32 may be extended in parallel at uniform intervals in stripe form.

In the shock detecting unit according to the present embodiment, the plurality of conductive patterns 32 are not limited to be in stripe form. For example, the plurality of conductive patterns 32 separated from each other at predetermined intervals are extended in the form of waves, are bent at least once, or are wound in the form of a screw.

In the shock detecting unit 30a according to the present embodiment, when no less than a predetermined degree of external shock is generated, broken parts 31a are formed in at least parts of the substrate 31 due to the force F applied to the substrate 31, and at least parts 34 among the conductive patterns 32 are broken at the moment when the substrate 31 is broken. In such a case, the resistance value of the parallel circuit of the conductive patterns 32 increases by stages or is infinite in accordance with the number of broken conductive patterns. The intensity of current which flows through the parallel circuit of the shock detecting unit 30a at uniform voltage is reduced by stages or is blocked. Such a change in the intensity of current may be sensed by the controller 20 of FIGS. 1A and 1B.

According to the present embodiment, the battery pack may calculate the amount of shock applied to the battery pack when the external shock is generated, for example, when the battery pack falls or collides, and may transmit or output that a problem generation factor, such as a short of the inside of the lithium secondary battery, is generated by the battery pack to the outside based on the amount of shock. At this time, the battery pack may display information such as “caution against re-shock is requested”, “shock is generated”, and “examination on A/S is requested due to the generation of shock” outside, or may transmit the information to the external system.

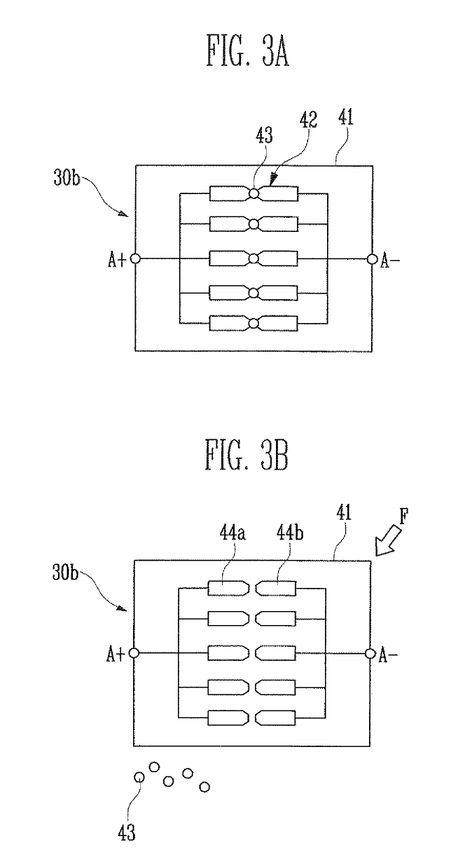

FIGS. 3A and 3B are schematic plan views illustrating a shock detecting unit of a battery pack constructed as another embodiment of the invention.

Referring to FIG. 3A, a shock detecting unit 30b includes a substrate 41 and a plurality of conductive patterns 42 mounted on the substrate 41. The conductive patterns 42 are electrically coupled to each other in parallel. Both ends A+ and A− are electrically coupled to the controller 20 of FIGS. 1A and 1B.

The substrate 41 may be actually the same as the substrate 31 of FIGS. 2A and 2B, except that the substrate 41 is not broken when no less than a predetermined degree of external shock is applied.

Each of the conductive patterns 42 includes first and second conductive layers 44a and 44b separated from each other at predetermined intervals. The plurality of conductive patterns 42 may be actually the same as the plurality of conductive patterns 32 of FIGS. 2A and 2B except that each of the conductive patterns 42 includes a pair of conductive layers 44a and 44b.

The shock detecting unit 30b according to the present embodiment includes a conductive fuse member 43 for electrically coupling the first and second conductive layers 44a and 44b to each other.

The conductive fuse member 43 is separated from the substrate 41 when no less than a predetermined degree of external force F is applied to the substrate 41 due to the external shock generated when the battery pack falls as illustrated in FIG. 3B.

According to the present embodiment, when the intensity of current which flows through the parallel circuit at a predetermined voltage is reduced by stages due to an increase in the resistance value of the parallel circuit, the controller 20 (FIGS. 1A and 1B) coupled to the shock detecting unit 30b (FIGS. 3A and 3B) may easily sense such a change in the intensity of current. That is, the battery pack according to the present embodiment senses the amount of shock applied to the battery pack when the external shock is applied, and may transmit or output that the problem generation factor, such as a short of the inside of the lithium secondary battery, is generated by the battery pack to the outside based on the amount of shock.

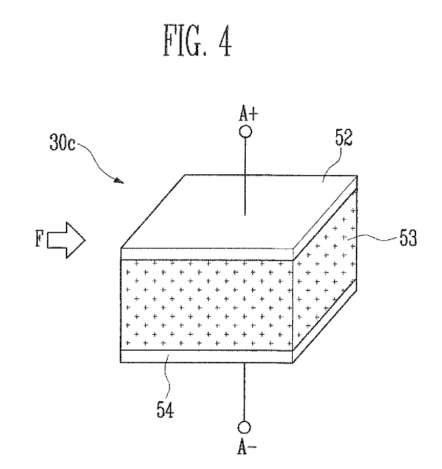

FIG. 4 is a schematic perspective view illustrating a shock detecting unit of a battery pack constructed as still another embodiment of the invention.

Referring to FIG. 4, a shock detecting unit 30c includes a shock sensor which generates a voltage or current at a level corresponding to the intensity of shock when the external shock is applied to the battery pack, that is, when the battery pack falls or collides. Both terminals A+ and A− of shock detecting unit 30c are coupled to the controller 20 of FIGS. 1A and 1B.

The shock sensor may be a piezoelectric type acceleration sensor using a piezoelectric material 53. For example, the shock sensor may include two electrodes 52 and 54 and the piezoelectric material 53 is interposed between the two electrodes 52 and 54. In addition, the shock sensor may be a shear type piezoelectric element for generating charges in positive electrodes 52 and 53 in response to shear stress. When a potential difference is generated between both surfaces of the shear type piezoelectric element, the current or voltage corresponding to the potential difference may be sensed by the controller 20 (FIGS. 1A and 1B).

The shock detecting unit 30c using the piezoelectric type acceleration sensor may be attached on the external side of the battery pack. The battery pack may be mounted on a laptop computer or an electric bicycle.

According to the present embodiment, when the external shock is applied, that is, when the external battery falls or collides, the battery pack senses the amount of shock applied to the battery pack or to the lithium secondary battery in the battery pack through the shock detecting unit 30c, and transmits or outputs that the problem generation factor, such as a short of the inside of the lithium secondary battery, is generated by the battery pack to the outside based on the amount of shock.

The above-described shock detecting units 30a, 30b, and 30c may be applied to the shock detecting unit 30 of the battery pack 100 described with reference to FIGS. 1A and 1B.

In addition, the battery pack according to the present embodiment may limit the charge and discharge operations of the secondary battery in the battery pack in response to the shock information sensed by the shock detecting unit.

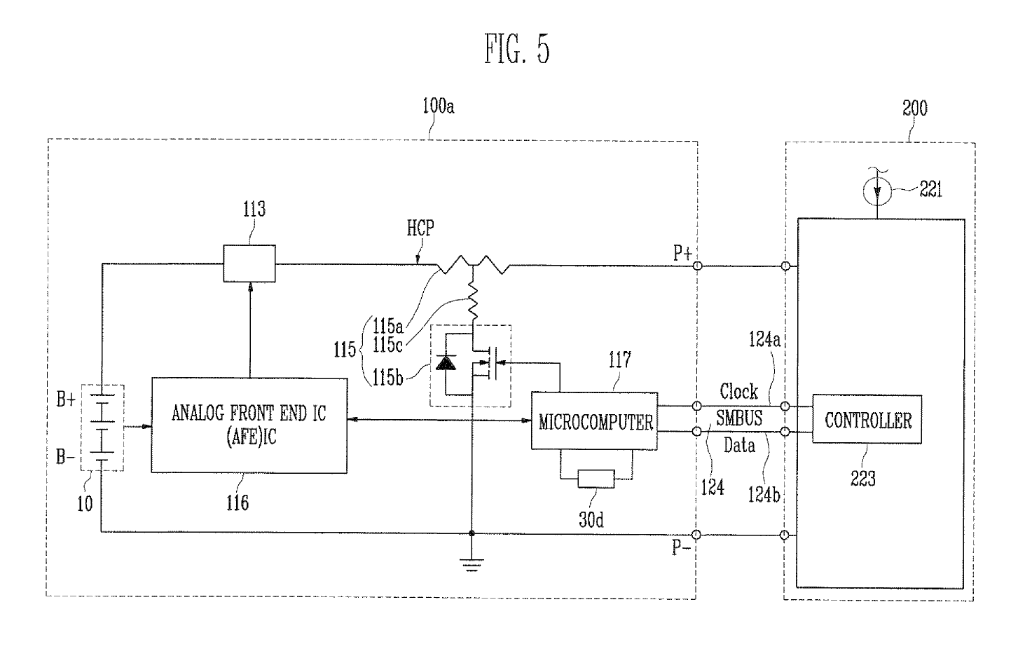

FIG. 5 is a schematic circuit diagram illustrating the controller of the battery pack constructed as an embodiment of the invention.

Referring to FIG. 5, a battery pack 100a includes a battery cell 10, a protective circuit module, and a shock detecting unit 30d. The battery pack 100a coupled to an external system 200 may supply power to the external system 200 or may be charged by the external system 200. The external system 200 may be coupled to a commercial power source through an adaptor 221. The external system 200 may include the portable laptop computer and the electric bicycle.

The protective circuit module corresponds to the above-described controller. The protective circuit module includes at least one switching element 113 for charge and discharge, a blocking unit 115, an analog front end (hereinafter, referred to as AFE) IC 116, and a microcomputer 117. The blocking unit 115 is coupled to a high current path (HCP) between the switching element 113 and the first power source terminal P+. The AFE IC 116 is coupled to the battery cell 10 and the switching element 113. The microcomputer 117 is coupled to the blocking unit 115 and the AFE IC 116.

The blocking unit 115 may include a fuse 115a, a heater 115c, and a control switch 115b. In this case, the fuse 115a is coupled between one end of the switching element 113 and the first power source terminal P+. The gate terminal of the control switch 115b is coupled to the microcomputer 117. The source terminal of the control switch 115b is grounded. The heater 115c is coupled between one end of the fuse 115a and the drain terminal of the control switch 115b.

The AFE IC 116 is coupled between the battery cell 10 and the switching element 113 in parallel, and is serially coupled between the battery cell 10 and the microcomputer 117. The AFE IC 116 transmits the voltage of the battery cell 10 to the microcomputer 117 and controls the operation of the switching element 113 by the control of the microcomputer 117. For example, in the charge mode of the battery cell 10, the AFE IC 116 sets the charge switch in the switching element 113 to an “on” state, and sets the discharge switch in the switching element 113 to an “off” state so that the battery cell 10 is charged. Similarly, in the discharge mode of the battery cell 10, the AFE IC 116 sets the charge switch in the switching element 113 to an “off” state and sets the discharge switch in the switching element 113 to an “on” state so that the battery cell 10 is discharged.

The microcomputer 117 controls the operation of the entire protective circuit module. The microcomputer 117 controls the switching element 113 through the AFE IC 116 so as to block the overcharge, the overdischarge, and the overcurrent of the battery cell 10.

According to the above structure, the protective circuit module turns on the control switch 115b in response to the external shock sensed by the shock detecting unit 30d so as to limit the charge and discharge of the battery cell 10. For example, the microcomputer 117 activates the control switch 115b of the blocking unit 115 so that the high current of the HCP is induced to the heater 115c through the fuse 115a. The heater 115c, heated by the induced high current, melts the fuse 115a. Therefore, the flow of current of the HCP is blocked and the charge voltage and/or current is supplied to the damaged battery cell 10 so as to prevent the ignition or explosion of the battery cell 10.

In addition, the protective circuit module may include an SMBUS 124 provided between the microcomputer 117 and an external terminal 112 for communications with the external system 200. The SMBUS 124 corresponds to a control line or a control terminal for transmitting control signals. The control signals include a signal for transmitting information on the estimated damage of the battery cell 10 caused by the external shock. Information on the battery cell 10 and/or information on the state of the battery cell 10 with respect to the external shock are synchronized with the clock signal of the clock line 124a of the SMBUS 124 so as to be transmitted to the external system 200 through a data line 124b.

While the present invention has been described in connection with certain exemplary embodiments, it is to be understood that the invention is not limited to the disclosed embodiments but, on the contrary, is intended to cover various modifications and equivalent arrangements included within the spirit and scope of the appended claims, and equivalents thereof.

What is claimed is:

1. A battery pack, comprising:
battery cells which are coupled via one of serial coupling, parallel coupling, and a combination of serial coupling and parallel coupling;
a shock detecting unit for detecting external shock; and
a controller coupled to the battery cells and to the shock detecting unit for outputting sensed shock information to the outside.

2. The battery pack as claimed in claim 1, wherein the shock detecting unit generates one of a voltage and a current in a level corresponding to an intensity of the external shock.

3. The battery pack as claimed in claim 1, wherein the shock detecting unit comprises a substrate and a plurality of conductive patterns mounted on the substrate and electrically coupled in parallel with each other.

4. The battery pack as claimed in claim 3, wherein at least parts of the plurality of conductive patterns are broken together with the substrate by the external shock.

5. The battery pack as claimed in claim 3, wherein each of the conductive patterns comprises first and second conductive layers separated from each other by a predetermined distance, and wherein the first and second conductive layers are coupled to each other by a conductive fuse member.

6. The battery pack as claimed in claim 5, wherein the conductive fuse member deviates from its right place due to the external shock so as to electrically separate the first and second conductive layers from each other.

7. The battery pack as claimed in claim 1, wherein the shock detecting unit comprises a shock sensor for generating one of a voltage and a current in a level corresponding to the external shock.

8. The battery pack as claimed in claim 7, wherein the shock detecting unit comprises a piezoelectric type acceleration sensor.

9. The battery pack as claimed in claim 1, further comprising an external terminal including a pair of power source terminals coupled to the battery cell.

10. The battery pack as claimed in 9, further comprising an output unit for outputting information on the external shock.

11. The battery pack as claimed in claim 10, wherein the output unit is provided in the external terminal, is coupled to the controller, and transmits control signals to an external system.

12. The battery pack as claimed in claim 10, wherein the output unit comprises one of a light output apparatus, a sound output apparatus, and a vibration apparatus coupled to the controller.

13. The battery pack as claimed in claim 1, wherein the controller comprises a blocking unit for blocking charge and discharge of the battery cell.
